(19) United States
(12) Patent Application Publication
(10) Pub. No.: US 2008/0010421 A1
(43) Pub. Date: Jan. 10, 2008

(54) Snapshot expansion system and method thereof

(75) Inventors: Yuen-Hong Chen, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/482,803

(22) Filed: Jul. 10, 2006

(51) Int. Cl. G06F 12/16

(52) U.S. Cl. 711/162

(57) ABSTRACT

A snapshot expansion system and a method, applicable to a logical volume manager, are provided. A snapshot space is allocated in a volume group space of a logical volume (LV) to create a snapshot. When a data write request is sent to the LV, the total capacity of the snapshot is compared with the current stored data volume of the snapshot space, thereby obtaining a difference representing the size of the remaining capacity of the snapshot space. Then, whether the difference is smaller than a preset value is detected. When the difference is smaller than the preset value, a capacity space is measured off in the volume group space to expand the capacity of the snapshot space through a standard expansion algorithm. The snapshot expansion system and method are capable of ensuring sufficient snapshot space to accommodate backup data, thereby ensuring availability of the snapshot.

### BACKGROUND OF THE INVENTION

1. Field of Invention

The present invention relates to a snapshot expansion method of a logical volume manager (LVM).

2. Related Art

A logical volume manager (LVM) is used to divide a hard disk space into several “flexible” logical volumes (LV) and is a mechanism to manage disk partitions in the Linux environment. What's more, LVM is a logical layer created based on the hard disk and partitions to enhance the flexibility of disk partition management. With LVM technology, a hard disk may be divided again without repartitioning. LVM makes disk management more flexible. The flexibility of LVM is further used to partition several physical disks with different types and sizes into multiple LVs, i.e., virtual partitions, and manage the multiple LVs.

Snapshots are a favorable characteristic of LVM. The snapshot is a backup mode directing LVs and can be created for an LV, in order to remain the read-only data backed up in the original disk or reserve the several versions of online data. The snapshot only records original values of changed positions in a corresponding LV to realize the function of high-speed backup, which is referred to as Copy on Write (COW). When a request for writing data is sent to one position in the LV, the original logical data in the position is backed up in advance, thereby realizing the function of high-speed backup.

When the snapshot is created, a snapshot space should be measured off in an LV firstly for storing the data changed during the existence of the snapshot. Substantially, the size of the snapshot is random, but the snapshot space should be sufficient. A snapshot storage space should be allocated in the LV before the snapshot is created. If the snapshot storage space is allocated insufficiently when the LV is created, the storage space may be run short before a snapshot is finished. For example, under certain circumstances, if the data volume increases as the changed addresses in the original LV increase, and exceeds the size of the snapshot, the snapshot cannot reserve the additional data. As a result, the backup data cannot be compared with the original data, thereby the snapshot is invalidated. Furthermore, if the LV is a block device, the above situation may be more likely to occur. If such a situation really happens, the snapshot data will be destroyed, thereby making the previous snapshot unavailable.

### SUMMARY OF THE INVENTION

In view of the aforementioned problems, an object of the present invention is to provide a snapshot expansion system of a logical volume manager (LVM) and a method therefore applicable to an LVM. The capacity of a snapshot space will be expanded automatically if the remaining capacity of the snapshot space is reduced to a certain size, thereby solving the problems and defects of the conventional technology.

Accordingly, in order to achieve the aforementioned object, the snapshot expansion system disclosed by the present invention comprises an allocation module, a detection module, and an expansion module. Herein, the allocation module is used to allocate a snapshot space in a volume group space of an LV to create a snapshot. The detection module is used to compare the total capacity of the snapshot space with the current stored data volume of the snapshot space to obtain a difference representing the remaining capacity of the snapshot space and then compare the difference with a preset value. The expansion module is used to measure off a capacity space in the volume group space and expand the capacity of the snapshot space through a standard expansion algorithm.

According to the snapshot expansion system of the present invention, when the capacity expansion of the snapshot space fails, the detection module marks the snapshot as an invalidated snapshot.

According to the snapshot expansion system of the present invention, a snapshot module is further provided. When the capacity expansion of the snapshot space succeeds, the snapshot module is used to perform COW on the data corresponding to a data write request, thereby backing up the data into the snapshot.

Additionally, the snapshot expansion method disclosed by the present invention is applicable to an LVM. The method comprises allocating a snapshot space in a volume group space of an LVM to create a snapshot; comparing the total capacity of the snapshot space with current stored data volume of the snapshot space when a data write request is sent to the LV, thereby obtaining a difference representing the size of the remaining capacity of the snapshot space; detecting whether the difference is smaller than a preset value or not; and when the difference is smaller than the preset value, measuring off a capacity space in the volume group space and expanding the capacity of the snapshot space through a standard expansion algorithm.

According to the snapshot expansion method of the present invention, the allocated snapshot space occupies 10% to 20% of the volume group space.

According to the snapshot expansion method of the present invention, the method further comprises marking the snapshot as an invalidated snapshot when the capacity expansion of the snapshot space fails; and copying the data corresponding to a data write request into the snapshot before data is written into the LV.

The snapshot expansion system and method therefore disclosed by the present invention are used to detect the size of the remaining space of the snapshot before data is written in the copies, and expand the capacity of the snapshot space automatically when the remaining space is smaller than a preset value. Therefore, the present invention ensures sufficient space to accommodate the backup data of the snapshot, and protects the snapshot from being invalidated, thus ensuring availability of the snapshot.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a flow chart of the steps of the conventional snapshot management method;

FIGS. 2 to 3 are flow charts of the steps of a snapshot expansion method of the present invention; and

FIG. 4 is a system block diagram of the snapshot expansion system of the present invention.

### DETAILED DESCRIPTION OF THE INVENTION

The features and practices of the present invention will be illustrated below in detail through the preferred embodiments accompanied with drawings.

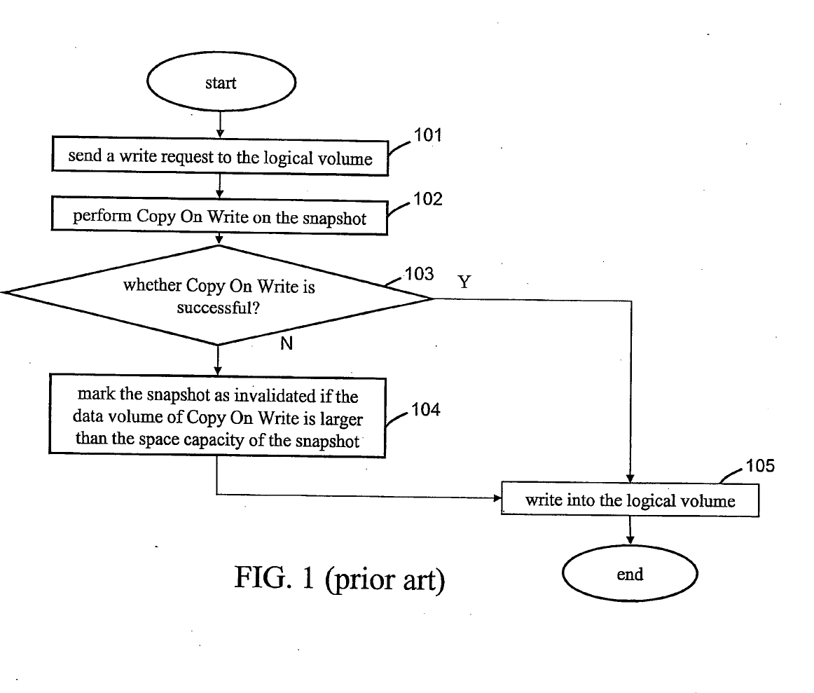

Refer to the conventional snapshot management technology before the snap expansion method of the present invention is illustrated. FIG. 1 shows a conventional snapshot management method. With reference to FIG. 1, when a write request is sent to the data in an LV by the system (Step 101) and after the LVM management module has detected the snapshot corresponding to the request, Copy On Write (COW) is performed on the snapshot (Step 102), in order to backup the data at the address in the LV, wherein data is to be written into the address. Then, whether COW of the snapshot is successful or not is determined (Step 103). If yes, the process goes to Step 105 to write the data in the address of the LV. Otherwise, it means that the data volume of COW exceeds the space capacity of the snapshot space and the snapshot is marked as invalidated (Step 104), so the snapshot is discarded and will not be used any longer. Next, the write operation is performed on the LV directly (Step 105). According to the conventional management method, if the preset snapshot space is small and multiple COWs are performed in response to multiple modifications in each of the addresses of the LV, the total data volume recorded in the snapshot is increased correspondingly. When the data modification in the LV exceeds the remaining space capacity of the created snapshot, the snapshot will be invalidated because it cannot store the superfluous data. If the preset snapshot space is too large, the snapshot space may be wasted because it cannot be fully used.

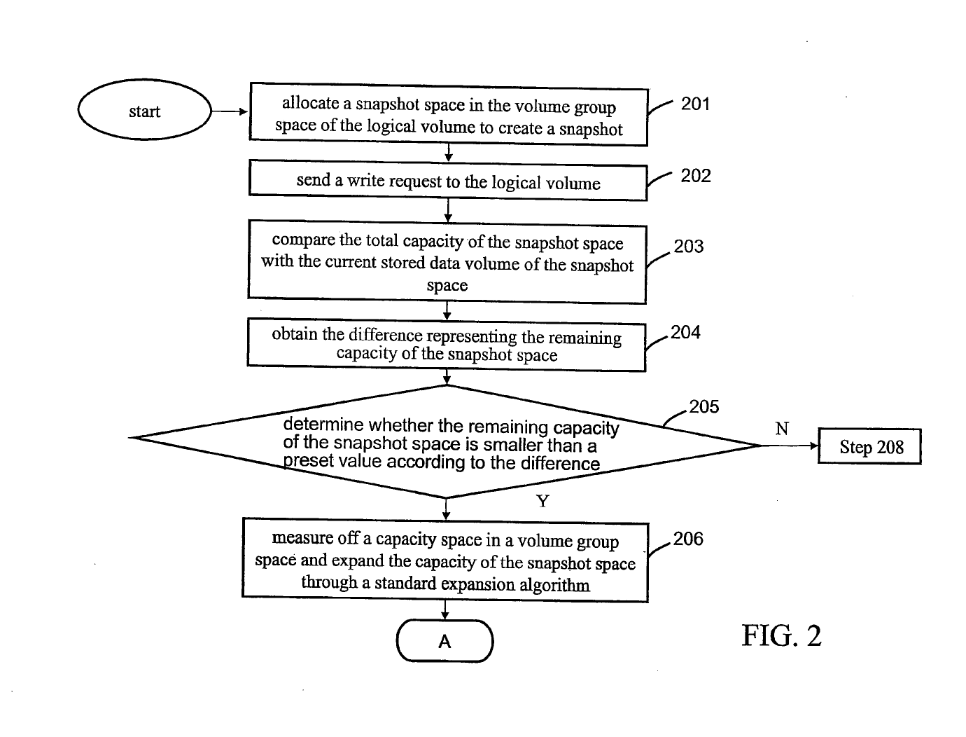

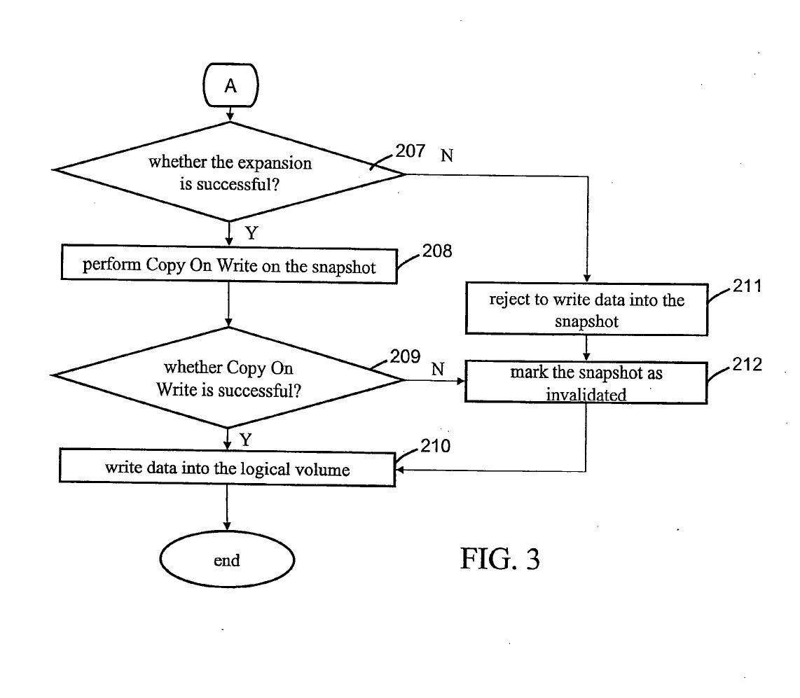

The snapshot expansion method of the present invention is illustrated below with reference to FIGS. 2 and 3, which are flow charts of the steps of the snapshot expansion method of the present invention. As shown in FIGS. 2 and 3, firstly, a snapshot space is allocated in a volume group space of an LV to create a snapshot (Step 201). When the LV is created for the first time or the LV receives a snapshot request for the first time, before a snapshot is created, the LV should have a snapshot space and then the snapshot may be stored in the snapshot space by the system. The snapshot space is allocated as the LV is created, which is of great advantage to ensure that the snapshot has sufficient available space. Generally, the size of snapshot space is random but should be sufficient to store all data changed during the existence of the snapshot. If the allocated snapshot space runs short, the snapshot cannot be used, and if the allocated snapshot space is too large, the space may be wasted. Not all the data in all addresses in the original LV will be changed, but the data to be changed often centers on some particular addresses, therefore, the size of the snapshot space set to be allocated here only occupies 10% to 20% of the corresponding LV.

After the snapshot space is allocated, when a write request is sent to the LV, the data in the address of the LV is backed up (Step 202) according to the COW technology, wherein data will be written into the address, and the data in the address will be stored into the empty snapshot created at the beginning. After the snapshot is created, the subsequent modification to the data in the original LV will be stored in the snapshot space. With the increase of the backup data, the remaining space in the snapshot decreases correspondingly. Furthermore, the longer the snapshot remains, the more snapshot space is needed. Therefore, before data is written into the LV again, the total capacity of the snapshot space needs to be compared with the current stored data volume of the snapshot (Step 203), thereby detecting whether the snapshot has the remaining space to continue backing up data. A difference representing the size of the remaining capacity of the snapshot space is obtained through the comparison (Step 204). Then, the difference is compared with a preset value to determine whether the current remaining space capacity of the snapshot is smaller than the preset value or not (Step 205), wherein the preset value is a predetermined value representing space capacity used for determining in advance whether the snapshot is invalidated due to the space being extremely small. The preset value may be selected from 5% to 8% according to the snapshot space occupying 10% to 20% of the LV group space, or selected from other values according to practical situations, such as the size of the data to be written into the LV. If the difference is determined to be smaller than the preset value, the current remaining space of the snapshot may be insufficient to store the data corresponding to the current write request. Therefore, a capacity space should be further measured off in the volume group space of the LV and the current snapshot space is expanded through the standard expansion algorithm (Step 206). The size of the measured off capacity space may be the same as that of the initially allocated snapshot space or may be determined according to practical situations. The standard expansion algorithm is a conventional expansion technology. If the difference is not smaller than the preset, the process goes to Step 208. Symbol A in the figure indicates the subsequent steps of the snapshot expansion method disclosed by the present invention.

After the snapshot is expanded, it is necessary to determine whether the expansion is successful or not (Step 207). If the expansion fails, it means that the LV has no remaining space to be allocated to the current snapshot, so data is rejected to be written into the snapshot (Step 211). Furthermore, the snapshot is marked as invalidated (Step 212). The invalidated snapshot indicates that the snapshot cannot be used to recover the original state of the LV and cannot be used to perform COW on the LV either. Therefore, the data is written into the LV directly (Step 210). If snapshot expansion is successful, COW is performed on the snapshot, thereby copying the data in the address corresponding to the write request to the expanded snapshot (Step 208). Further, whether the operation of COW is successful or not is determined (Step 209). If yes, the data is written into the LV (Step 210). Otherwise, the snapshot is marked as invalidated, i.e., the snapshot cannot be used to recover the original state of the LV (Step 212). Thus, all steps of the snapshot expansion method of the present invention are finished.

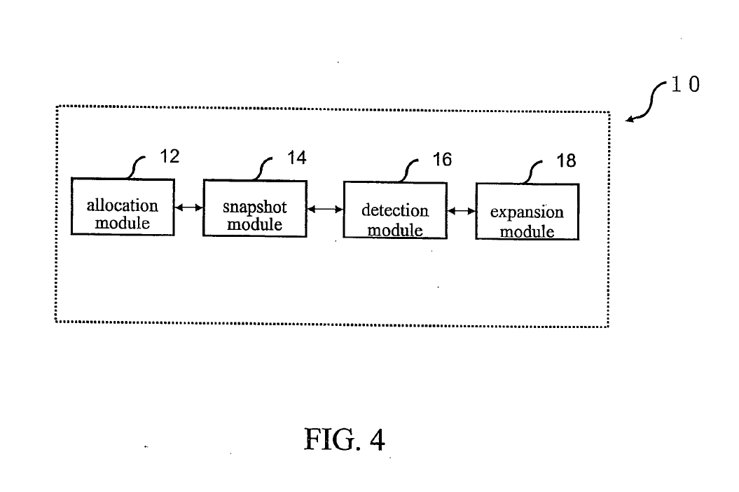

The snapshot expansion system of the present invention is illustrated with reference to FIG. 4 which is a system block diagram of the snapshot expansion system of the present invention.

With reference to FIG. 4, the snapshot expansion system 10 comprises an allocation module 12, a detection module 16, and an expansion module 18. The allocation module 12 is used to allocate a snapshot space in a volume group space of an LV to create a snapshot. Not the data in all addresses in the original LV will be changed, but the data to be changed often centers on some addresses, therefore, the size of the snapshot space set to be allocated here only occupies 10% to 20% of the corresponding LV.

The detection module 16 is used to compare the total capacity of the snapshot space with the current stored data volume of the snapshot space to obtain a difference representing the size of the remaining capacity of the snapshot space and then compare the difference with a preset value. The preset value is a predetermined value to represent the space capacity, such that the detection module 16 determines whether the snapshot is invalidated or not due to the space being extremely small before data is written into the snapshot space. The preset value may be determined depending on the size of the initially allocated snapshot space, experiences, practical situations, and so on. If the detection module 16 determines that the difference is smaller than the preset value, it means that the current remaining space of the snapshot may be insufficient to store the data corresponding to the current write request. At this time, the expansion module 18 should be activated.

The expansion module 18 is used to measure off a capacity space in the volume group space of the LV and expand the capacity of the snapshot space through a standard expansion algorithm. The size of the capacity space measured off in virtual space may be the same as that of the initially allocated snapshot space, i.e., 10% to 20% of the corresponding LV, or be determined according to experience. When capacity expansion of the snapshot space fails, the detection module 16 marks the snapshot as an invalidated snapshot. That is, the snapshot cannot be used to recover the original state of the LV and cannot be used to perform COW on the LV either.

Furthermore, according to FIG. 4, the snap expansion system of the present invention further comprises a snapshot module 14 for performing COW on the data corresponding to the data write request and backing up the data into the snapshot. If the capacity expansion of the snapshot space is successful, the detection module 16 activates the snapshot module 14 to perform COW on the LV and copy the data corresponding to the data write request into the snapshot before data is written into the LV. Then, the data is written into the LV. Thereby, with the present invention, not only is the snapshot space not wasted due to the space being too large, but also the snapshot will not be invalidated due to the increase of backup data and insufficient data space.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A snapshot expansion method applicable to a logical volume manager (LVM), comprising:
allocating a snapshot space in a volume group space of a logical volume to create a snapshot;
comparing the total capacity of the snapshot space with a current stored data volume of the snapshot space when a data write request is sent to the logical volume, thereby obtaining a difference representing the size of the remaining capacity of the snapshot space;
detecting whether the difference is smaller than a preset value or not; and
measuring off a capacity space in the volume group space and expanding the capacity of the snapshot space through a standard expansion algorithm when the difference is smaller than the preset value.

2. The snapshot expansion method as claimed in claim 1, wherein the snapshot space occupies 10% to 20% of the volume group space.

3. The snapshot expansion method as claimed in claim 1, wherein the method further comprises marking the snapshot as invalidated when capacity expansion of the snapshot space fails.

4. The snapshot expansion method as claimed in claim 1, wherein the method further comprises copying the data corresponding to the data write request into the snapshot before data is written into the logical volume, when capacity expansion of the snapshot space successes.

5. A snapshot expansion system applicable to an LVM, comprising:
an allocation module for allocating a snapshot space in a volume group space of a logical volume to create a snapshot;
a detection module for comparing the total capacity of the snapshot space with a current stored data volume of the snapshot space to obtain a difference representing the size of the remaining capacity of the snapshot space, and then comparing the difference with a preset value; and
an expansion module for measuring off a capacity space in the volume group space and expanding the capacity of the snapshot space through a standard expansion algorithm

6. The snapshot expansion system as claimed in claim 5, wherein the detection module marks the snapshot as an invalidated snapshot when capacity expansion of the snapshot space fails.

7. The snapshot expansion system as claimed in claim 5, wherein the snapshot space occupies 10% to 20% of the volume group space.

8. The snapshot expansion system as claimed in claim 5, further comprising a snapshot module for performing Copy On Write on the data corresponding to the data write request to backup the data into the snapshot, when capacity expansion of the snapshot space successes.
